(19) United States
(12) Patent Application Publication
(10) Pub. No.: US 2018/0266389 A1
(43) Pub. Date: Sep. 20, 2018

(54) METHOD FOR RETROFITTING A TOOTHED RETROFITTING UNIT ON A REAR EDGE OF A WIND TURBINE ROTOR BLADE AND A TOOTHED RETROFITTING UNIT FOR A WIND TURBINE ROTOR BLADE

(71) Applicant: Wobben Properties GmbH, Aurich (DE)

(72) Inventors: Sebastian ENGELHARDT, Aurich (DE); Uwe RAHMANN, Großefehn (DE); Jörg BAJEN, Utarp (DE)

(21) Appl. No.: 15/758,301

(22) PCT Filed: Sep. 7, 2016
(86) PCT No.: PCT/EP2016/071033

§ 371 Date: Mar. 7, 2018

(30) Foreign Application Priority Data
Sep. 10, 2015 (DE) 10 2015 217 331.3
Jan. 28, 2016 (DE) 10 2016 101 485.0

(51) Int. Cl. F03D 1/06; F03D 80/50

(52) U.S. Cl. CPC F03D 1/0675; F03D 1/0633; F03D 80/50; F05B 2260/96; F05B 2240/301; F05B 2250/183; F05B 2230/80

(57) ABSTRACT

A method of retrofitting a tooth unit to a trailing edge of a wind turbine rotor blade. A portion of the trailing edge of the rotor blade is cut out and removed. That can be affected when the rotor blade is still disposed on a hub of the wind power installation (that is to say in the mounted state). A tooth retrofitting unit is glued or adhesively fixed on the trailing edge of the wind turbine rotor blade in the cut-out and removed portion. The tooth retrofitting unit has a V-shaped profile and at its first side has two fixing arms and at an opposite side a plurality of teeth. The two fixing arms are adhesively secured to the trailing edge of the rotor blade to mount the tooth retrofitting unit.

### BACKGROUND

### Technical Field

The present invention concerns a method of retrofitting at least one tooth retrofitting unit to a trailing edge of a wind turbine rotor blade and a tooth retrofitting unit for a wind turbine rotor blade.

### Description of the Related Art

To increase the efficiency of a wind turbine the design of the rotor blades is of great significance. The rotor blades of a wind turbine have a suction side and a pressure side, those sides coming together at a trailing edge of the rotor blade. The pressure difference between the suction side and the pressure side can generate eddies which at the trailing edge of the rotor blade can involve noise emission and a reduction in power.

To reduce the noise emission and the reduction in power it is possible to provide teeth or prongs at the trailing edge of the rotor blade. The effectiveness in terms of noise reduction depends in that case on the geometry of the teeth.

On the German patent application from which priority is claimed the following documents were cited: DE 10 2012 109 989 A1, DE 10 2014 206 345 A1, U.S. Pat. No. 5,533,865 A and EP 2 667 019 A2.

### BRIEF SUMMARY

Provided is a method for obtaining a rotor blade having a tooth geometry at the trailing edge of the rotor blade even in the case of existing rotor blades. In particular, the present invention concerns a method of retrofitting a tooth unit to the trailing edge of a rotor blade in existing rotor blades.

Thus there is provided a method of retrofitting a tooth unit to a trailing edge of a wind turbine rotor blade. A portion of the trailing edge of the rotor blade is cut out and removed. That can optionally be effected when the rotor blade is still on a hub of the wind power installation (that is to say in the mounted state). A tooth retrofitting unit is glued or adhesively fixed on the trailing edge of the wind turbine rotor blade in the cut-out and removed portion. The tooth retrofitting unit has a V-shaped profile and at its first side has two fixing arms and at an opposite side a plurality of teeth. The two fixing arms are adhesively secured to the trailing edge of the rotor blade to mount the tooth retrofitting unit.

According to an aspect of the present invention the tooth retrofitting unit has a V-shaped profile and in the region of the fixing arms straps or flaps which can be laminated to a material of the trailing edge of the wind turbine rotor blade.

Provided is a method of retrofitting a tooth retrofitting unit to a rotor blade trailing edge of a wind turbine rotor blade. For that purpose a portion of the rotor blade trailing edge is cut out and removed while the rotor blade is still on a hub of a wind turbine. The rotor blade trailing edge has a hollow chamber which is partially open after removal of the portion of the rotor blade trailing edge. The tooth retrofitting unit has a first end having an adhesive strap, a central portion and a second end having a plurality of teeth. The adhesive strap is introduced into the hollow chamber at the rotor blade trailing edge and glued by means of adhesive. The adhesive can be provided in the hollow chamber.

Also provided is a tooth retrofitting unit for a wind turbine rotor blade. The retrofitting unit has a V-shaped profile, a first side having two fixing arms and an opposite side having a plurality of teeth. The two fixing arms can be adhesively secured to the trailing edge of the rotor blade.

In a further aspect of the present invention, the retrofitting unit has a V-shaped profile and in the region of the fixing arms straps or flaps which can be laminated to a material of the trailing edge of the wind turbine rotor blade.

Provided is a method of retrofitting a tooth unit or a serration unit in relation to existing rotor blades of a wind turbine, more specifically in particular when the rotor blades are still fixed to the hub of the wind turbine.

For that purpose a portion or cut-out section is cut out of a trailing edge of the rotor blade. That portion or section is preferably disposed in the outer third of the rotor blade. After the portion or section has been removed a tooth retrofitting unit is fixed at that location. The tooth retrofitting unit can optionally be in the form of a V-shaped profile which at its first side has two fixing arms and at its opposite second side the teeth. According to an aspect of the present invention, the tooth retrofitting unit can be adhesively secured to the trailing edge of the rotor blade, more specifically at the location at which a portion or cut-out section of the trailing edge of the rotor blade has been removed. Optionally a heating unit can be temporarily provided in the region of the first side of the tooth trailing edge in order to harden the adhesive.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic view of a wind turbine according to the invention,

FIG. 2A shows a diagrammatic cross-section of a trailing edge of a rotor blade of a wind turbine,

FIG. 2B shows a diagrammatic view of a rotor blade according to the invention,

FIG. 3A and FIG. 3B respectively show diagrammatic views of a tooth retrofitting unit according to a first embodiment of the invention, and

FIG. 4 shows a diagrammatic cross-section of a trailing edge of a rotor blade of a wind turbine according to a second embodiment of the invention.

### DETAILED DESCRIPTION

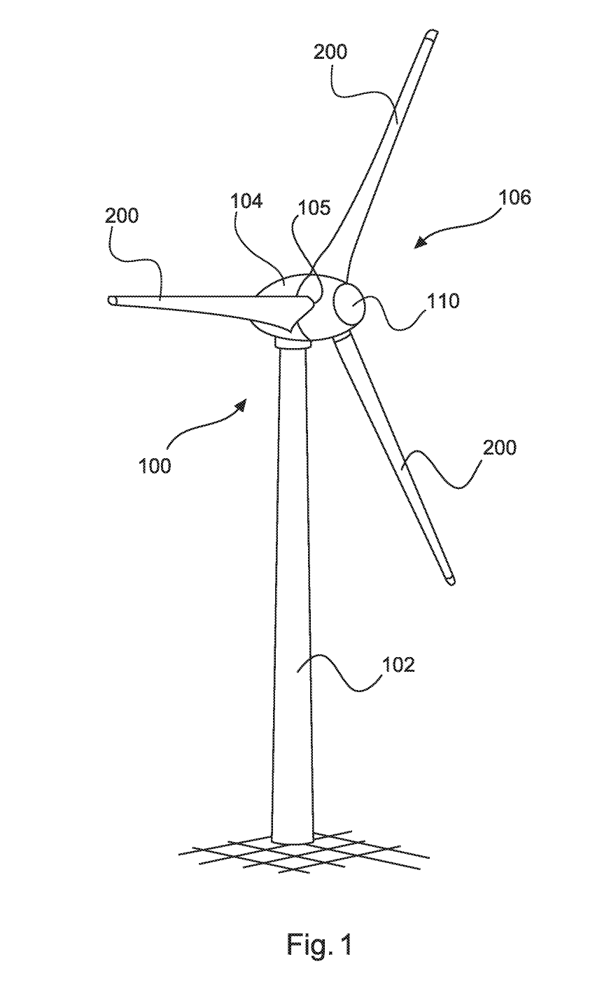

FIG. 1 shows a diagrammatic view of a wind turbine. The wind turbine 100 has a tower 102 and a pod 104 on the tower 102. Provided on the pod 104 is an aerodynamic rotor 106 having three rotor blades 200 and a spinner 110. The rotor blades 200 are respectively secured to a hub 105. The aerodynamic rotor 106 is caused to rotate by the wind in operation of the wind turbine and thus also rotates a rotor or rotor member of a generator which is directly or indirectly coupled to the aerodynamic rotor 106. The electric generator is arranged in the pod 104 and generates electrical energy. The pitch angles of the rotor blades 200 can be altered by pitch motors at the rotor blade roots of the respective rotor blades 200.

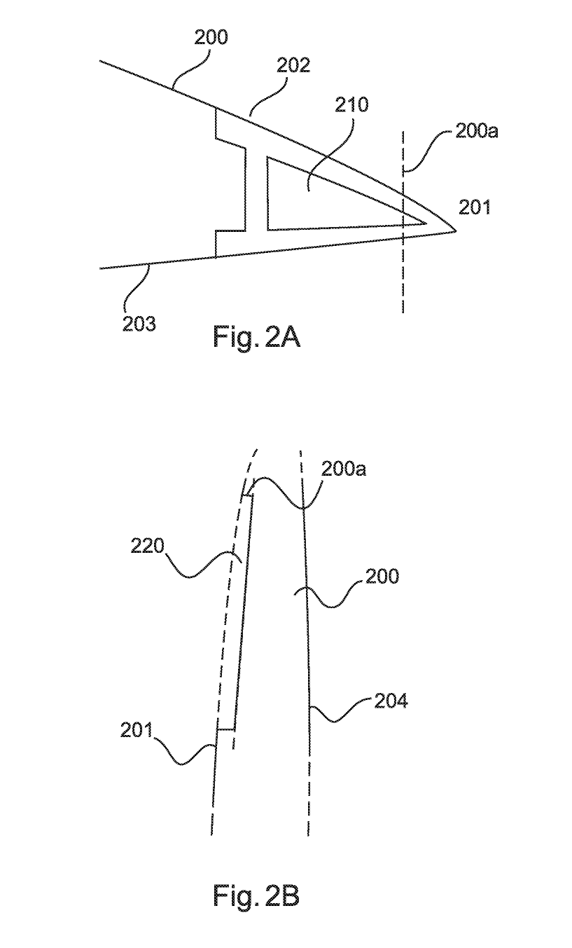

FIG. 2A shows a diagrammatic cross-sectional view of a trailing edge of a rotor blade. The rotor blade 200 has a trailing edge 201, a pressure side 202, a suction side 203 and optionally a hollow chamber 210 in the region of the trailing edge 201.

FIG. 2B shows a diagrammatic view of a rotor blade. The rotor blade has a leading edge 204, a trailing edge 201 and a cut-out portion 220 in the region of the trailing edge 201, which has been cut away or cut out. A tooth retrofitting unit is to be placed in that region 220.

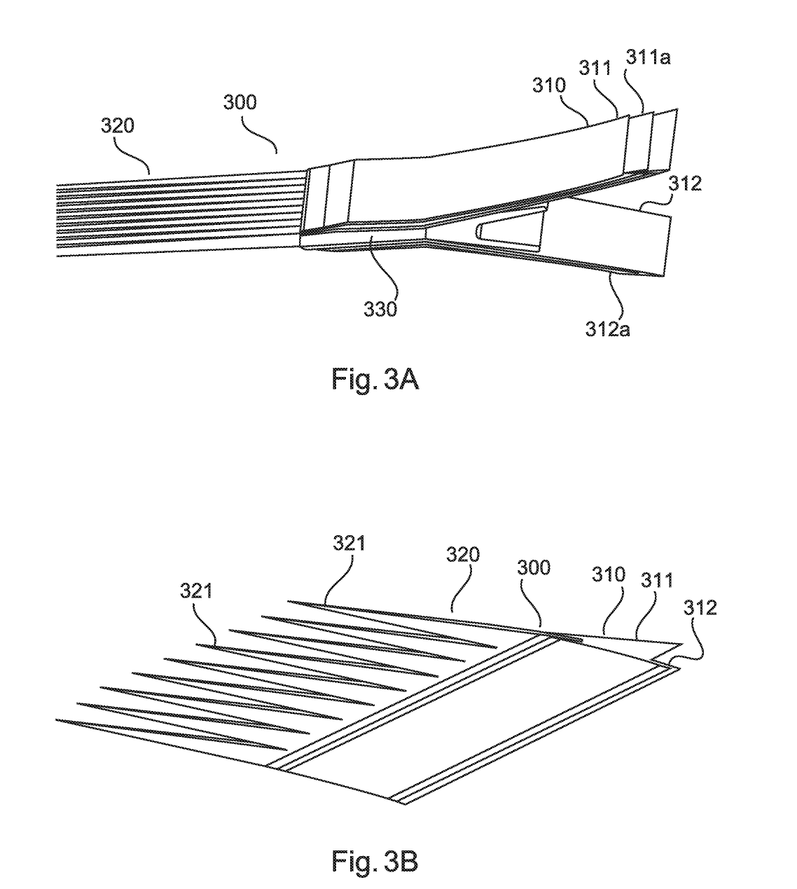

FIGS. 3A and 3B each show diagrammatic views of a tooth retrofitting unit according to a first embodiment. The tooth retrofitting unit 300 has a first end 310 for fixing to the trailing edge 201 of a wind turbine rotor blade 200. In addition the tooth retrofitting unit 300 at its second end 320 has a plurality of teeth 321.

The tooth retrofitting unit 300 can be in the form of a V-shaped profile which at its first end has two ends or arms 311, 312, by means of which the tooth retrofitting unit 300 can be fixed and in particular glued to a trailing edge 201 and in particular to the cut-out section or portion 220 of the trailing edge as shown in FIG. 2B. The tooth retrofitting unit 300 can have a V-shaped profile 330 and flaps or straps 311a, 312a in the region of the fixing arms 311, 312. A heating unit can be temporarily provided in that region for hardening the adhesive.

In order to obtain the cut-out portion 220 the trailing edge is cut away or cut out for example in the plane 200a. Optionally that is effected when the rotor blade for example still hangs vertically from the pod of the wind turbine. Accordingly the blades remain in the mounted state during fitment of the retrofitting unit 300.

The cutting-away operation can be effected for example by way of a hand-held circular saw and a rip fence.

The tooth retrofitting unit can be made from thermosetting materials, thermoplastic materials, elastomers or thermoplastic elastomers (TPE).

If there is a hollow chamber 210 then the retrofitted tooth unit 300 can be at least partially glued into the hollow chamber 210.

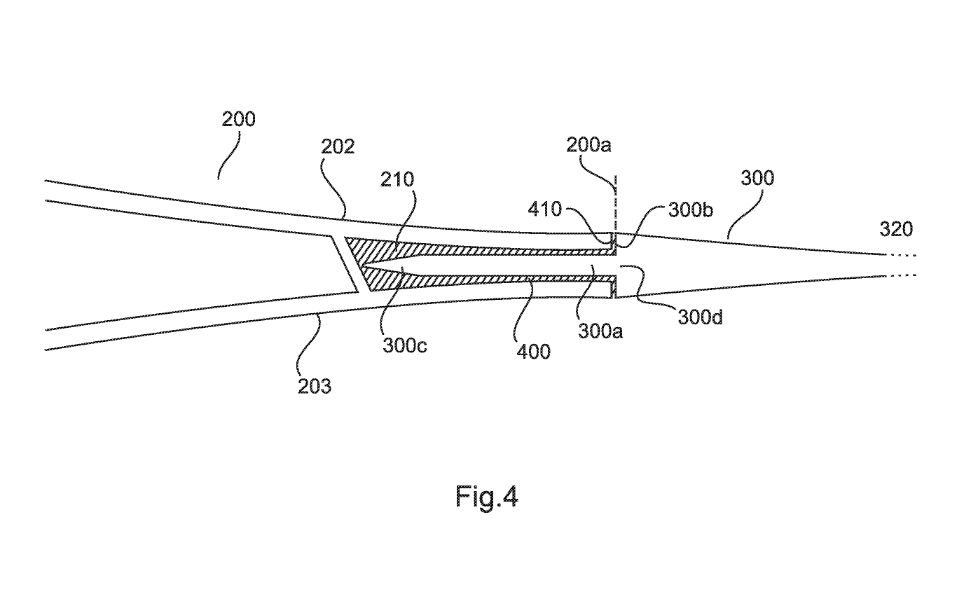

FIG. 4 shows a diagrammatic cross-section of a trailing edge of a rotor blade of a wind turbine according to a second embodiment. The trailing edge of the rotor blade 200 according to the second embodiment can substantially correspond to the trailing edge 201 of the rotor blade 200 of the first embodiment. The rotor blade 200 thus has a hollow chamber 210 at its trailing edge. In particular a part of the trailing edge 201 can be cut away or cut out as described with reference to FIG. 2B. The cutting-out or cutting-away operation can preferably be affected when the rotor blade is still mounted to the pod. For that purpose the rotor blade 200 can be turned for example into the 6 o'clock position so that it is arranged substantially vertically.

The hollow chamber 210 can then be at least partially filled with an adhesive 400.

The tooth retrofitting unit 300 according to the second embodiment has at its first side or its first end an adhesive strap 300a which optionally tapers to a point in the end region 300c. The opposite second end 320, as in the first embodiment, has a plurality of teeth 321. The tooth retrofitting unit has a central portion 300d which is adjoined by the adhesive strap 300a. There is a recess 300b on both sides between the adhesive strap 300a and the central portion 300b.

Upon mounting of the tooth retrofitting unit 300 the adhesive strap 300a is introduced into the hollow chamber 210 which is filled with adhesive 400. In that case adhesive 400 can pass to the exterior in the region of the recess 300b. That excess adhesive can be removed for example by means of a trowel and/or any recesses can be levelled therewith.

Optionally the tooth retrofitting units 300 can already be in a finished painted condition in the factory. Optionally the tooth retrofitting unit can be divided into a plurality of segments to improve handling of the segments.

1. A method of retrofitting an existing wind turbine rotor blade to include a tooth retrofitting unit at a rotor blade trailing edge of the wind turbine rotor blade, the method comprising:
cutting out and removing a portion of a rotor blade trailing edge of the existing wind turbine rotor blade while the wind turbine rotor blade is mounted to a hub of a wind turbine, and
fixing the tooth retrofitting unit on or to the trailing edge of the wind turbine rotor blade in the cut-out and removed portion,
wherein the tooth retrofitting unit has a V-shaped profile, wherein the tooth retrofitting unit has a first side having first and second fixing arms and an opposite second side having a plurality of teeth, and
wherein fixing the tooth retrofitting unit comprises fixing the first and second fixing arms on or to the rotor blade trailing edge.

2. The method according to claim 1 wherein the tooth retrofitting unit includes straps or flaps that are laminated to a material of the rotor blade trailing edge, wherein straps or flaps are located in an area of the first and second fixing arms.

3. A method of retrofitting an existing wind turbine rotor blade to include a tooth retrofitting unit at a rotor blade trailing edge of the wind turbine rotor blade, the method comprising:
cutting out and removing a portion of a rotor blade trailing edge of the existing wind turbine rotor blade while the wind turbine rotor blade is mounted to a hub of a wind turbine, and
fixing a tooth retrofitting unit on or to the trailing edge of the wind turbine rotor blade in the cut-out and removed portion,
wherein the tooth retrofitting unit has a first end having an adhesive strap, a central portion and a second end having a plurality of teeth, and
wherein the adhesive strap is fixed into a hollow chamber at the rotor blade trailing edge.

4-7. (canceled)

8. The method according to claim 3 wherein fixing the tooth retrofitting unit comprises using an adhesive to fix the tooth retrofitting unit on or to the trailing edge of the wind turbine rotor blade in the cut-out and removed portion.

9. The method according to claim 8 wherein the adhesive is glue.

10. The method according to claim 1 wherein fixing the tooth retrofitting unit comprises using an adhesive to fix the tooth retrofitting unit on or to the trailing edge of the wind turbine rotor blade in the cut-out and removed portion.

11. The method according to claim 10 wherein the adhesive is glue.
